(19) United States
(12) Patent Application Publication
(10) Pub. No.: US 2018/0087685 A1
(43) Pub. Date: Mar. 29, 2018

(54) CONE VALVE

(71) Applicant: Hans D. Baumann, W. Palm Beach, FL (US)

(72) Inventor: Hans D. Baumann, W. Palm Beach, FL (US)

(21) Appl. No.: 15/330,489

(22) Filed: Sep. 28, 2016

(51) Int. Cl. F16K 27/04; F16K 3/22; F16K 25/02

(52) U.S. Cl. CPC F16K 27/04; F16K 25/02; F16K 3/22

(57) ABSTRACT

A cone type control valve comprising a cone shaped valve plug movably retained in an similarly shaped opening of a valve housing having horizontal inlet and outlet ports and wherein any reciprocal movements of the conical plug can provide fluid flow from the inlet to the outlet port.

### BACKGROUND OF THE INVENTION

The invention describes a cone-style globe valve used for throttling of fluid or gases in applications typically found in the chemical, food or climate control applications using modulation valves to finely adjust the flow of fluid following signals from computerized control systems.

State of the art globe style control valves have been in use for centuries and comprise mainly a housing having an inlet and an outlet port, a central orifice connecting the ports and a vertically movable plug capable of selectively restricting the flow of fluid through the orifice. Such globe style control valves have to meet basic requirements besides reasonable cost such as meeting shut-off, an acceptable flow characteristic, low actuating forces and dynamic stability.

My invention constitutes an improvement over the current state of the art in that the design offers besides fewer parts, resulting in lower manufacturing cost, and greatly reduced force requirement enabling the use of smaller actuating devices for a given valve size, thereby again reducing cost and overall dimensions. In addition, the invention offers increased flow capacity per given orifice size. In contrast to conventional globe valves having single orifices, the invention offers two orifices in succession which can be closed simultaneously thereby substantially reducing the chances of fluid leaking across the valve. In contrast to typically solid valve plugs, the invention features a hollowed plug allowing fluid to pass from the bottom of the plug to the top thereby greatly reducing forces required to move the plug against high fluid pressures.

There are so-called plug valves consisting of a housing having two opposed ports where the housing is centrally intersected by a horizontal opening having a conical shape and holding therein a rotatable cone having a horizontal opening aligning after every ninety degree rotation with the opposed ports in order to pass fluid. Such valves are almost exclusively used for the closure of pipes. The rotable cones exhibit a high degree of rotary friction requiring powerful rotary actuators for opening or closing such valves. This type of valve is un-suitable for modulating control since the high friction creates a hysteresis effect, which is very detrimental for stable control. Furthermore, the circular flow paths create very little hydraulic friction and therefore are not suited for pressure reduction.

The fact that the invented cone separates immediately from a similarly shaped conical opening in a housing upon lift-off, is thereby eliminating the undesirable friction exhibited by the aforementioned plug valves. Furthermore, a drain opening is provided connecting the housing interior between two ports to the outside, the valve thus being able to evacuate any fluid leakage from the upstream orifice before fluid is able to affect the downstream orifice when the valve is in the closed position. Thus, the invention could serve as a “block and bleed” device. These and other novel features may be gleaned from the following description.

### BRIEF DESCRIPTION OF THE DRAWINGS

FIG. 1 is a central, cross-sectional view of a preferred embodiment of the invention in a closed valve position.

FIG. 2 is a cross-sectional view of the central portion of the cone valve along the line A-A in FIG. 1, showing the conical plug in the open position.

FIG. 3 showing a horizontal, cross-sectional view of the top of the conical plug along the lines B-B in FIG. 2.

FIG. 4 shows a schematic view of a state of the art globe valve.

FIG. 5 shows a schematic view of a state of the art rotary plug valve.

### DETAILED DESCRIPTION

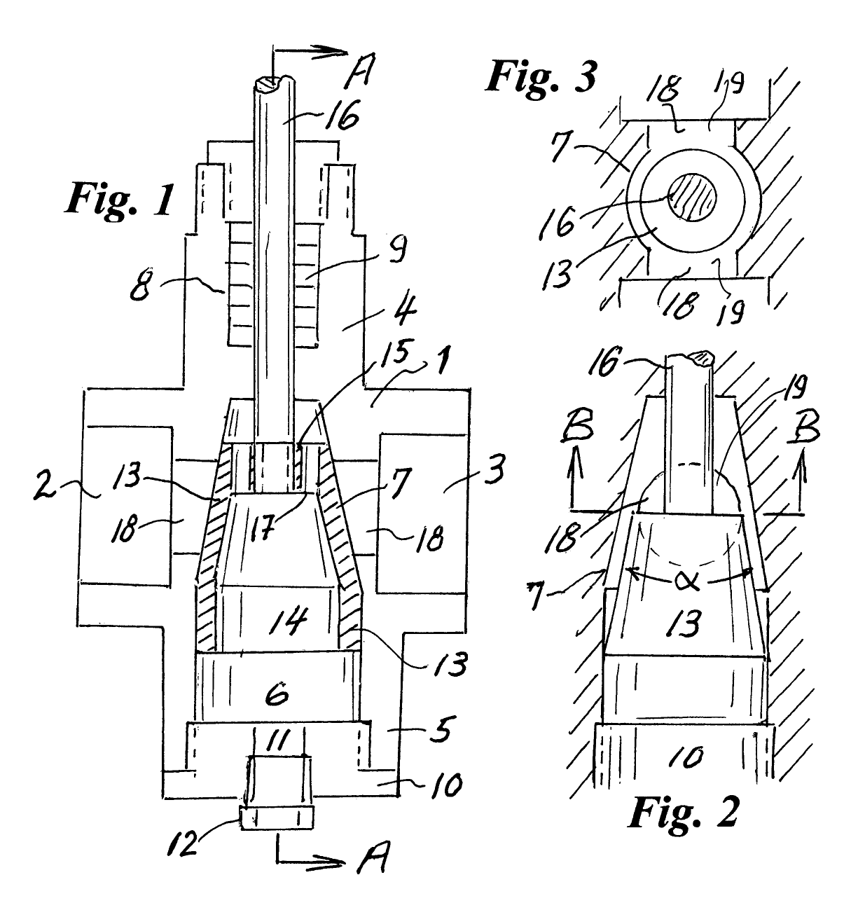

Referring to FIG. 1, showing the cross-sectional view of the invention which is comprised of a housing (1) having an inlet port (2) and an outlet port (3) on a common horizontal axis. The housing having an upper extension (4) and a lower extension (5).

Housing (1) having central vertical openings commencing with a larger circular bore (6), followed by a conical bore (7) extending through the horizontal axis having inlet and outlet ports. The conical bore (7) terminates into a reduced bore (8) containing therein a valve packing (9). A threaded closure (10) seals the large circular bore (6) to prevent escape of fluid. A drain hole (11) being part of the closure and sealed by a plug (12) allows fluid evacuation from the housing if need should arise.

A conical plug (13) slidingly engaging the circular bore (6) has a conical extension fitting snuggly into the conical bore (7) of the housing. The plug (13) has a hollow recess (14) terminating in a flattened closure (15) suitably fastened to a valve stem (16) which extends through the upper extension (4) and which is furthermore sealed by valve packing (9). The flattened closure has a number of small ports (17) allowing for communication of fluid between the top and bottom of the conical plug (13). Two opposed orifices (18) extending the inlet and outlet port opening to the conical housing bore (7).

The functions of the invention can be described as follows: In the closed valve position as shown in FIG. 1, the outer surface of the conical plug (13) is in close contact with the conical bore (7) and thereby blocks both orifices (8) to prevent escape of fluid from the inlet port (2). This is an important feature since even if there is leakage from the orifice close to the inlet port, this leakage is still prevented from reaching the orifice located near the outlet port (3). Such leakage furthermore can be drained from the circular bore (6) through opening (11). The invention thus could serve as a shut-off valve for hazardous fluids.

Following a command signal from a control system, stem (16) is pushing the conical plug (13) down and starts opening the valve to admit fluid from the inlet to the outlet port. At the beginning of travel, the flow area is defined as the travel distance times 0.5 times the tangent of cone angle times the diameter of orifice (18). In an example, given a travel of 2 mm, a cone angle α of 25 degrees and an orifice diameter of 18 mm, here the flow area would be 8 mm², thus allowing for very small quantities of fluid. In addition to the described flow areas between the distance between the conical surfaces of both plug (13) and conical bore (7), at increased valve travel, an additional flow path (19) is provided between the two orifices (18) as shown in FIGS. 2 and 3. Assuming a travel of 18 mm here the flow area is the sum of (18×0.5×tan α×18)+0.5×18²×3.14×0.25=408 mm². These examples proves that the invention can achieve a wide control range of between 8 and 408 mm2 or, a range of 50:1.

An important consideration in the design of a control valve is to reduce the amount of force required to open or close the valve plug under fluid pressure. In order to reduce the force requirement the plug (13) in the invention is partly balanced thru access holes (17) to allow a pressure balance between the top and the bottom of the conical plug (13). Furthermore, the only area subjected to inlet pressure when the valve is closed is the difference in cone diameter over the length of the orifice (18) times its diameter. In the above example with an 18 mm diameter of orifice (18) and a cone angle of 25 degrees and the average diameter of the cone plug of 25 mm, this area calculates to 18×18×tan(25/2)=71 mm². Thus, with an inlet pressure of 10 bar, a force of 7. kg is needed to operate the invention. This compares favorably to a conventional globe plug diameter of 25 mm having an area subject to inlet pressure of 466 mm² needing 47 kg of force for 10 bar inlet pressure. This comparison shows that the invented valve can provide substantial savings in the size of actuating devices.

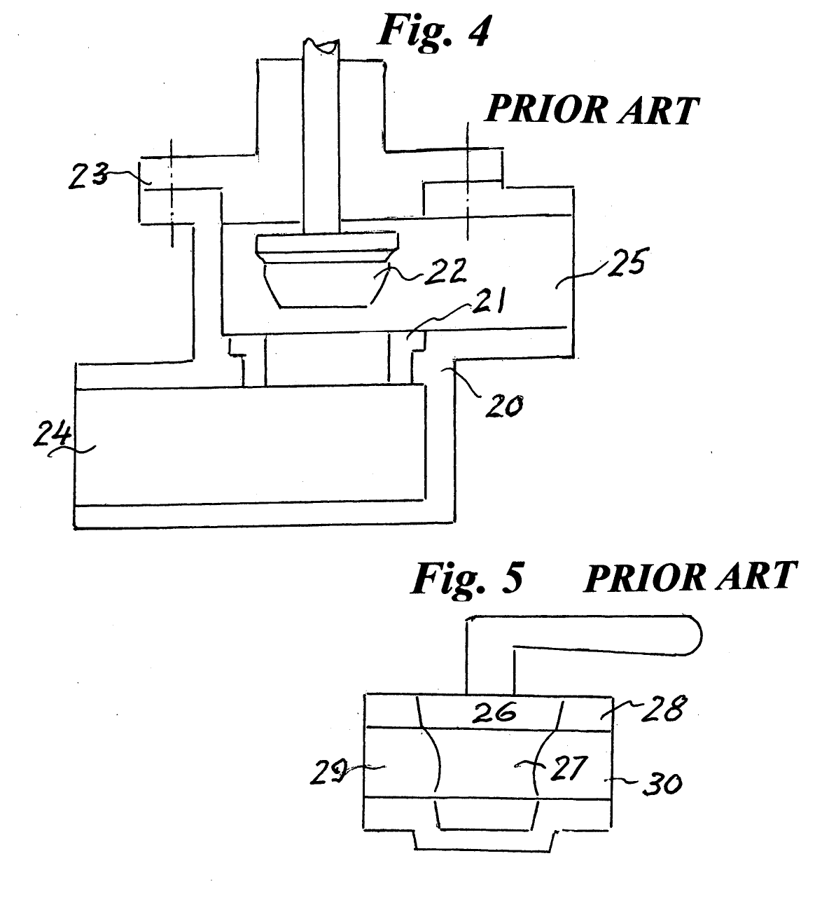

A typical state of the art globe valve is shown in FIG. 4 comprising a housing (20), an orifice seat ring (21), a valve plug (22) and a cover (23) to close the upper housing opening. Fluid enters an inlet port (24) passes between the plug and seat ring and exits outlet port (25). In the closed valve position, the pressure of the incoming fluid will exert a force on the circular area of the plug diameter as described above. Besides high force requirements, valves of this type are expensive due in part that they require more machined parts in comparison to the invented valve and require more metal. Furthermore, they have no dual seating features compared to the invention and therefore are more leak prone. Finally, such globe valves have less flow capacity due to the fact that the fluid has to pass a tortuous path across the valve in comparison to the invention, where, in the open position, fluid can travel nearly unhindered from the inlet side of orifice (18) to the outlet side, thereby increasing flow capacity due to lesser fluid resistance.

A rotary cone type valve is exhibited in FIG. 5, commonly called a plug valve. This is a rotary device consisting of a housing (28) having a vertical conical plug (26) with a central horizontal bore (27) able, in any 90 degrees rotational position, to communicate with inlet port (29) and outlet port (30). Valves such as this have virtually no fluid resistance and therefore are not suitable for control of fluid since any control involves throttling action. Furthermore, these valves have no defined flow characteristic common with state of the art globe valves and the current invention. As a result, such plug valves are used almost exclusively for on-off applications.

While the invention has been demonstrated in a preferred embodiment, nothing shall preclude from making additional modifications without departing from the scope of the following claims. For example, it is anticipated that the housing can be made in two different sections, that orifices (18) could have a triangular shape instead of being round, or that pipe flanges could be attached to both inlet and outlet ports.

1. A cone type control valve comprising a housing having opposed and connected inlet and outlet ports located on a horizontal axis and a vertical axis intersecting the horizontal inlet and outlet ports, said vertical axis has a conical opening, a conical plug designed to fit snuggly into the conical opening of the housing and being capable to block communication between inlet and outlet ports, a stem having one end suitably connected to the conical plug while the opposed end is connected to a reciprocating actuating device and whereby any vertical movements of the conical plug, following the commands of the actuating device, will allow selective amounts of fluid to pass from the inlet to the outlet port, a portion of said stem being enclosed by suitable sealing means being enclosed in said housing to prevent escape of fluid from the housing.

2. A cone type control valve as described in claim 1, wherein said conical bore of the housing has a cylindrical extension capable of guiding a similar cylindrical extension of the conical plug.

3. A cone type control valve as described in claim 1, wherein closure means are suitably connected to the housing to close the cylindrical extension portion of the housing.

4. A cone type control valve as described in claim 1, wherein the conical plug has a recessed opening along the major length of the plug terminating in a flattened closure portion retaining the stem and likewise having one or more bores to allow fluid pressure to equalize between the bottom and the top of the conical plug.

5. A cone type control valve as described in claim 3, wherein the closure means features an opening capable of draining fluid from the interior of the housing.
